(19) United States
(12) Patent Application Publication
(10) Pub. No.: US 2003/0057324 A1
(43) Pub. Date: Mar. 27, 2003

(54) Anti-ballistic, secure bulkhead, or partition for a commercial airliner

(76) Inventor: Michael A. Meszaros, Tampa, FL (US)

Correspondence Address: Michael A. Meszaros, 14901 GLASGOW CT, TAMPA, FL, 33624, US

(21) Appl. No.: 09/956,738

(22) Filed: Sep. 18, 2001

(51) Int. Cl. B64C 1/00

(52) U.S. Cl. 244/119

(57) ABSTRACT

The invention provides a security system for pilots of a commercial airliner, in the event of a hi-jacking attemt. The method involves the use of a ceramic composite and/or poly carbonate laminate material for the construction of a barrier or Bulkhead in serparating passenger cabin and pilot's cockpit, which is either transparent or opaque and consists of a gasket or o-ring inbetween outer bulkhead edge and walls, ceiling and floor of aircraft to provide shock absorption and/or to provide an air-tight compartment for separating atmospheric and oxygen levels in each compartment.

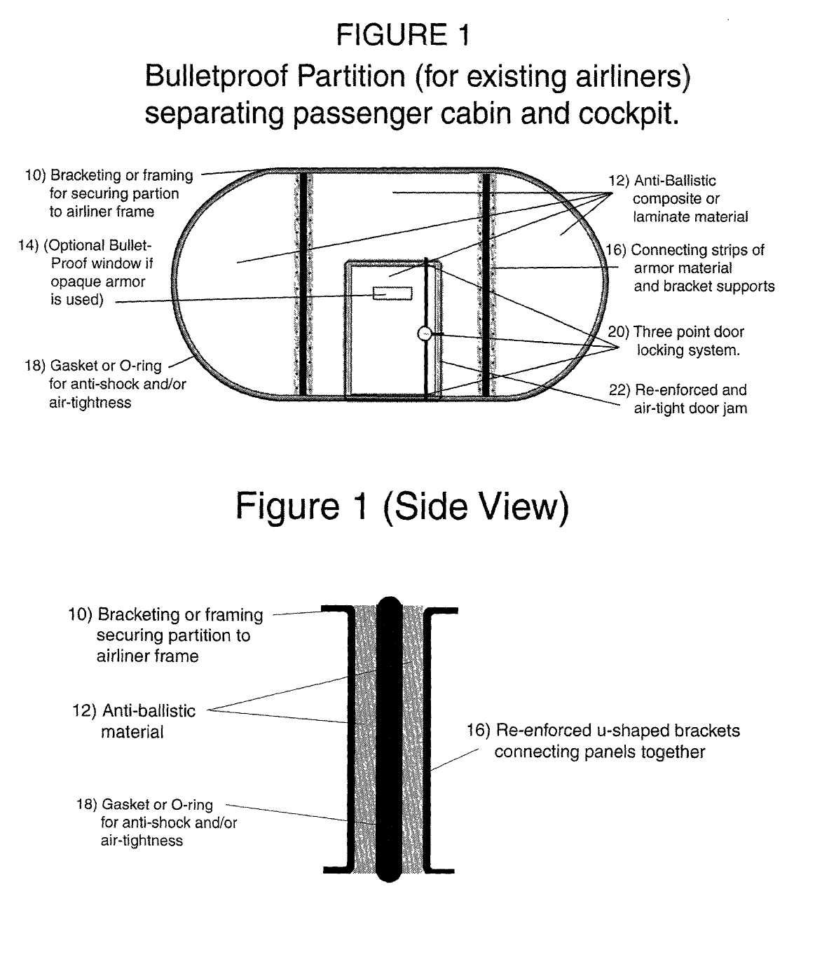

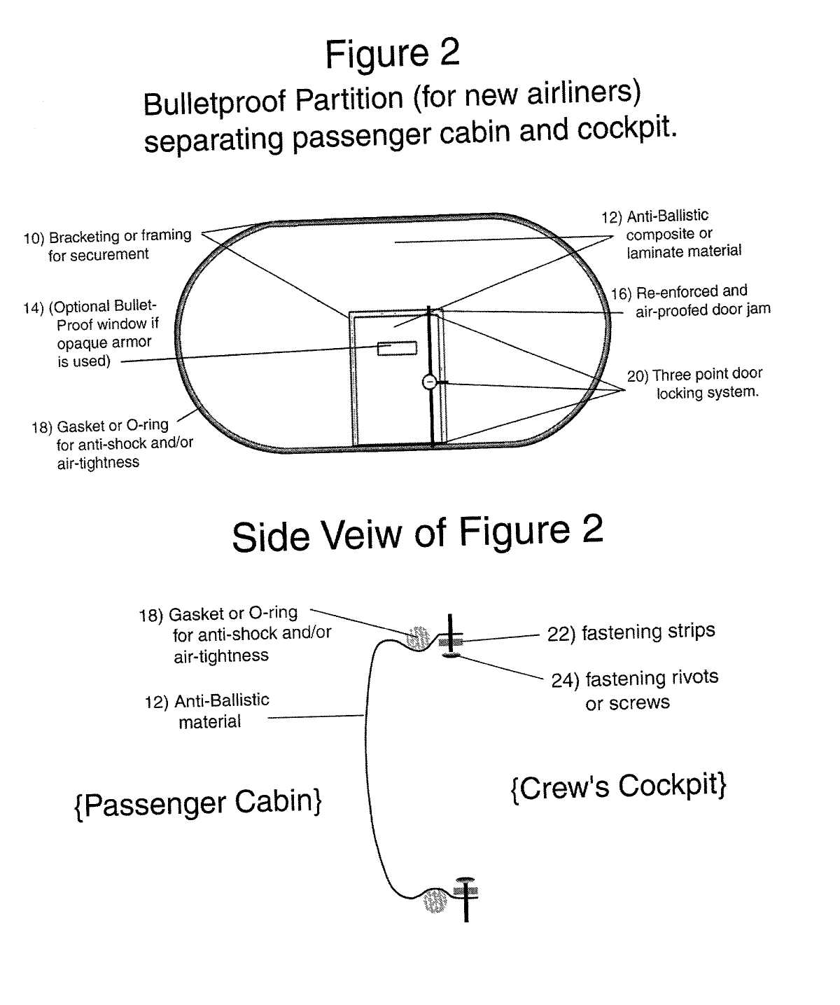

### REFERENCES CITED

| | | | |
|---|---|---|---|
| H1,519 | March 1966 | Semple | 89/36.02 |
| 522,788 | January 1966 | Semple | 89/36.00 |
| 4,027,443 | June 1977 | Brigs | 52/202 |
| 4,061,815 | December 1977 | Poole Jr. | 428/215 |
| 4,126,730 | November 1978 | Molari Jr. | 428/412 |
| 4,316,404 | February 1982 | Medlin | 89/36.08 |
| 4,352,316 | October 1982 | Medlin | 89/36.02 |
| 4,621,856 | November 1986 | McKenzie | 296/24.1 |
| 4,709,950 | December 1987 | Zortman | 292/92 |
| 4,982,585 | January 1991 | Davis | 70/269 |
| 5,487,323 | January 1996 | Madden Jr. | 89/36.08 |
| 5,554,328 | September 1996 | Kondakov | 264/122 |
| 5,622,580 | April 1997 | Mannheim | 156/106 |
| 5,911,763 | June 1999 | Quesada | 70/120 |
| 6,009,289 | January 2000 | Lyons | 89/36.02 |
| 6,161,005 | December 2000 | Pinzon | 455/403 |

### DETAILED DESCRIPTION

This invention relates to an anti-ballistic, secure bulkhead for commercial airliners to provide adequate protection of pilots and secure control of airliner from attempted hi-jackings.

Presently available bulkheads separating the passengers cabin from the pilots cockpit in a commercial airliner offers very little protection.

It is the object of this invention to obtain adequate protection for the cockpit of the airliner.

Many lightweight, anti-ballistic, heat resistant, composite and/or laminated materials, composed of ceramic, fiberglass fiber, and/or polycarbonate materials woven or bonded together have been patented and many will suit the needs for the intended invention. Two such patented materials are mentioned, but other types of materials may be used as long as they adhear to the properties of being anti-ballistic in nature.

Anti-Ballistic

Patent #H1,519 Semple “A transparent ceramic armor comprising a light weight composite of transparent material with an areal density 16.4 pounds per square foot adapeted to shatter on impact projectiles with a muzzle valocity of approximately 3000 f.p.s.”

Lightweight

Patent #H1,519 Semple “improved capability of protection as compared to standard steel armor of equal areal density.”

Transparent:

Patent #H1,519 Semple “Transparent ceramic armor consisting of a lightweight composite formed by utilizing a face plate of transparent aluminum oxide or transparent magnesium oxide with a back-up plate of transparent plastic and the two plates bonded together with transparent adhesive.”

material. Although other known anti-ballistic materials may be substituted since being transparent is not a high, but could be beneficial, priority.

One such “other” anti-ballistic material we have researched, and trade-offs the transparent feature of Semple's material for high-heat resistance is:

U.S. Pat. No. 5,554,328 Kondakov “The invention provides a ceramic composite material which includes 50-90% boron carbide, 5-30% silicon carbide, and 3-22% titanium carbide. All constitutes are in powder form, and have a particle size of between 1 and 40 microns, and a purity of at least 97%. The powdered constitutes are blended and consolidated by hot isostatic pressing (HIPing). The properties of this material tested using samples 130 mm in diameter and 6-10 mm thick, and ballistic tests were conducted by firing a thermo-hardened bullet from a AK-47 (bullet velocity 890 m/s) and standard bullet from a M16 (985 m/s) from a distance of 5 meters.were observed as:

| | |
|---|---|
| Density | 2.7-2.82 g/cm sup. 3 |
| Porosity | 2-3% |
| Elastic Modulus | 430-440 Gpa |
| Hardness | 30-40 Gpa |
| Melting | 2,300-2,500 Degrees Celsius Decomposition″ |
| Thermal Expansion | 5-6 coefficient |
| Bending Strength | 380-410 Mpa |
| Bending Strength | .gtoreq. 400 @ 1,700 degrees Celsius |
| Fracture Toughness | 10-15 Mpa .times. m. sup. 1/2 |
| Ballistic Testing | 35-45 (Damaged area around impact point) |

Anti-ballistic applications appear to be particularly promising. In this regard, the material behaves in an unusual manner, in that upon impact by a bullet or other projectile, an armor plate made of the present material does not resist impact to a point and then shatter catastrophically. Instead the present ceramic material deforms without shattering catastrophically, by resisting the impacting projectile to a certain point and then punctures, with a concomitant formation of a damaged area around the impact point. This permits repeated hits before having a plate failure.”

Another object of this invention is to provide a secured passage way to and from passenger cabin and cockpit. Almost all modern airliners require pilots to enter the airliner through the main door located in the passenger cabin and to then enter a door located in the bulkhead to enter the cockpit. The current doors of these bulkheads do not offer much security from an un-wanted intruder. The object of this patent would to provide a secure door also manufactured of ant-ballistic material(s) and having a re-enforced Door frame, hinge, and jam. Ideally a seal making this door airtight could be beneficial as a last level of security as explained later. Optionally if a non-transparent anti-ballistic material is used to construct the door of bulkhead a “Fire and impact resistant window assembly U.S. Pat No. 4,027,443 June 1977 Briggs” could be pre-constructed in door as to give pilots a view of going-ons in passenger compartment. If transparent armor was used for bulkhead an door, pilots could have a clear view of passenger cabin and vise versa. This would also be beneficial for pilots to see if intruder is hiding near door.

What is claimed is:

1. An Anti-Ballistic, secure Bulkhead or Partition for a commercial airliner. A sectioned, (for existing airliners) or one piece Bulkhead (for new installations) comprising of bulletproof, Anti-Ballistic, and/or heat resistant materials. Brackets or frame for holding said in place. Door and lock system for said Bulkhead entrance and exit. Gasket or O-Ring for Anti-Shock and/or air tightness to keep area's atmospheric conditions separated from one another.
The method as recited in claim 1., wherein; the Bulkhead would be constructed of high impact, Anti-Ballistic and/or heat resistant materials composed of laminates or composite materials either bonded and/or woven together.
The method as recited in claim 1., wherein; the sectioned Bulkhead would be constructed of Anti-Ballistic panels, shaped small enough to pass-through existing airliners largest cabin door and constructed on-site by attachment to airliners frame system with brackets or inner framing system. Sections would be reinforced at vulnerable joints with bonded strips of same or other anti-ballistic material optionally including the use of paired re-enforced U-brackets.
The method as recited in claim 1., wherein; the one piece Bulkhead for installation in new aircraft could in fact be 1 piece conformed to fit partitioned off area, with preformed or cut opening for door. Doorframe and/or (Jam) will be reinforced and also be airtight as well. A timed and/or ground controlled 3-point electronic locking system on bulkhead door offers logical un-locking and locking control. The method as recited in claim 1., wherein; a Gasket or O-Ring, may be used in between walls, floor, and ceiling of aircraft and partition for the purpose of cushioning partition from strain and/or to make cockpit AIRTIGHT for the method of controlling atmospheric and/or oxygen conditions in each compartment.
